(19) United States
(12) Patent Application Publication
(10) Pub. No.: US 2010/0050462 A1
(43) Pub. Date: Mar. 4, 2010

(54) Body exsiccation chamber

(75) Inventor: Joseph Francis Attonito, Pembroke Pines, FL (US)

Correspondence Address: MAYBACK & HOFFMAN, P.A., 5722 S. FLAMINGO ROAD #232, FORT LAUDERDALE, FL, 33330, US

(73) Assignee: Joseph Francis Attonito, Pembroke Pines, FL (US)

(21) Appl. No.: 12/231,224

(22) Filed: Aug. 29, 2008

(51) Int. Cl. F26B 25/06

(52) U.S. Cl. 34/201

(57) ABSTRACT

An exsiccation system provides a chamber for drying persons or animals in a fast, efficient and antibacterial manner. A series of apertures throughout the chamber provides jets of warm air directed onto a body in the chamber. The warm air removes moisture and exits out of the entrance to the chamber. The air flow into the chamber is optimized by adjusting the size of the outlets into the chamber. A control panel allows an operator to adjust the airflow and temperature of the exsiccation chamber.

### CROSS-REFERENCE TO RELATED APPLICATIONS

None

### STATEMENT REGARDING FEDERALLY SPONSORED RESEARCH OR DEVELOPMENT

None

### REFERENCE TO SEQUENCE LISTING, A TABLE, OR A COMPUTER PROGRAM LISTING COMPACT DISC APPENDIX

None

### BACKGROUND OF THE INVENTION

1. Field of the Invention

The present invention relates to an exsiccation apparatus and system for drying a body or other object. More specifically, the invention relates to a drying chamber for removing the exterior moisture of a person in a rapid, comfortable manner that discourages propagation of microorganisms.

2. Prior Art

Electric body dryers can be a convenient and clean replacement for towel drying. They reduce laundering costs and improve the unsanitary conditions associated with towel drying, particularly in locker rooms, hotels, and public washrooms. Problems of towel theft are also eliminated. A body dryer would also be useful in a home, as either a replacement for or supplement to towel drying. Towel drying can be insufficient, particularly in a damp shower area, or in warm, humid weather. After a shower or bath, one is frequently left with a damp, sticky feeling which can be eliminated with a body dryer.

U.S. Pat. No. 6,131,303 discloses a body dryer consisting of a vertical tube having a series of air holes that blow warm air. This invention only allows a narrow area to be dried at one time. It does not concentrate the heated air in a confined area and is therefore very inefficient.

U.S. Pat. No. 7,076,887 discloses a remotely operated apparatus having a long vent and that may be fit into the corner of a shower stall. This invention also provides warm air from only a single direction. The invention includes an extended vent traversing its front wall. It is designed to be added to a shower stall and must be constructed to be resistant to the effects of water permeating its structure.

U.S. Pat. No. 6,829,841 discloses a drying cabinet having manifolds that supply air to a plurality of nozzles that project warmed air into the cabinet. The nozzles regulate the direction and force of air flow within the cabinet. The cabinet includes a door and a drain. Air flow into the cabinet is regulated by adjusting individual nozzles. Adding additional nozzles to the cabinet requires adding manifolds about the structure. This rapidly results in a complex, heavy structure that is time consuming to manufacture and install.

U.S. Pat. No. 5,752,326 discloses a personal dryer having a series of fans arranged to create an airflow having a vortex motion within a chamber. The structure requires multiple fans or other ventilators and is complex to construct.

U.S. Pat. No. 6,148,539 discloses a body dryer having two channels along the sides of a chamber with vents that supply warm air. No provision is made for adjusting the air flow through the vents relative to one another.

U.S. Pat. No. 6,067,725 discloses a cylindrical drying chamber in which the plenum through which warmed air travels aids in distributing air pressure among the outlets. Although this disclosure describes a method for distributing air pressure horizontally, it is ineffective in evenly distributing air pressure along the vertical axis. This invention recognizes the problem of equal distribution of airflow from a plenum into a chamber. However, the method disclosed for addressing this problem is limited in that it only is effective in a single, horizontal, direction and requires a crescent shaped plenum and substantially cylindrical chamber. Plenums that are shaped differently may not benefit from this disclosure.

It is therefore desirable to provide an exsiccation system having a chamber capable of quickly drying a person or other object.

It is also desirable to provide an exsiccation system having a chamber capable of quickly drying a person or other object in which an operator may adjust the air flow through the chamber and the temperature of the air flowing into the chamber.

It is also desirable to provide an exsiccation system having a chamber capable of quickly drying a person or other object in which a plurality of outlets through which air flows into the chamber are variably sized such that each outlet has an optimized air flow rate relative to the other outlets.

### BRIEF SUMMARY OF THE INVENTION

The present invention provides a system and method to impinge a plurality of heated air streams evenly over the body of a person or animal to quickly and comfortably remove excess water. The invention overcomes the problems associated with the prior art by providing equal air flow from all of the nozzles of a drying chamber without the need for a complex manifold. Optionally, the air flow from the nozzles may be adjusted relative to each other such that when the air flow rate of the plenum from which they are fed changes, the air flow rates from each of the outlets change equally. In this manner, the air flow rates from each outlet maintain the same ratios with each other regardless of the overall flow rate of air into the plenum and chamber. The invention allows for adjustment of the air stream strength and temperature. The chamber is easy and inexpensive to install and is readily adapted to accommodate a veneer or alternative surfacing to enhance its aesthetic qualities.

The exsiccation chamber includes an inner wall having a plurality of outlets through which heated air inters the chamber. The inner wall is formed by several flat panels or by a single cylindrical panel. An outer wall surrounds the inner wall and creates a plenum between the inner and outer wall. An ventilator draws air in from a vent and blows it across a heating element. The air is then provided to the plenum. The size of the openings or nozzles in the inner wall increases with the distances from the ventilator. This pattern allows air to stream out all of the nozzles from the plenum and into the drying chamber at substantially the same pressure. The warm air and moisture exits through the entrance portal to the chamber.

The exsiccation chamber may also be adapted for use with animals. The chamber may include a gate on the portal so that a cat or dog may be retained in the chamber while it is dried. An alternative exsiccation chamber with both an entrance portal and an exit portal may be used with larger animals such as horses.

The invention also includes a control panel for adjusting the air pressure of the drying air, the temperature and preferably includes a timer.

In use, a wet person having just left a shower walks through the portal and into the exsiccation chamber. He or she turns the chamber on and adjusts the air flow and heat to desired levels. Warm air passes through the plenum and out the outlets and directly onto the operator's body. Because the size of the outlets increase with increasing distance from the plenum's source of air, the rate of air flow through all of the outlets is substantially equal. The air and moisture exit through the portal. When the operator is sufficiently dry, he or she turns off the warm air supply and exits the chamber through the portal.

It is therefore an object of the invention to provide a comfortable method of drying a living body or other object with use of a towel.

It is another object of the invention to provide an expedient means of drying a pet or other animal.

It is another object of the invention to provide a method of air drying an object using a air outlets having equilibrated air pressure without the use of a manifold.

### BRIEF DESCRIPTION OF THE DRAWINGS

FIG. 1 is a perspective view of an exsiccation chamber of the invention.

FIG. 2 is a front view of an exsiccation chamber of the invention.

FIG. 3 is a cross sectional top view of an exsiccation chamber of the invention

FIG. 4 is a perspective view of an exsiccation chamber of the invention showing the interior of the ventilation housing.

FIG. 5 is a cut away side view of an exsiccation chamber and ventilation housing of the invention.

FIG. 6 is a cross sectional side view of a nozzle of the invention.

FIG. 7 is a perspective view of an alternative embodiment of the invention.

FIG. 8 is a rear view of an alternative embodiment of the invention.

FIG. 9 is a cut away side view of an alternative embodiment of the invention.

FIG. 10 is a perspective view of an alternative embodiment of the invention.

FIG. 11 is a perspective view of an alternative embodiment of the invention.

FIG. 12 is a cut away front view of an alternative embodiment of the invention.

### DETAILED DESCRIPTION OF THE INVENTION

The exsiccation chamber of the present invention includes a chamber into which warm, drying air is fed by means of several apertures and/or nozzles in the walls of the chamber. A ventilator provides air to a plenum that surrounds the chamber. The ventilator receives air from an external vent and blows it across a heating element. The heated air enters the plenum formed between the walls of the drying chamber and an outer wall. Air exits the plenum and enters the chamber through several outlets in the chamber wall. The outlets vary in size, typically with larger outlets being located further from the plenum's air source. The airflow is adjusted such that air pressure from the outlets remains constant throughout the drying chamber. The outlets may optionally include interchangeable nozzles so that a person installing or providing maintenance to the chamber may adjust the relative air flow rates of the various nozzles to satisfy the preferences of the user or owner. For example, a person with a relatively large midsection and thin legs may prefer greater airflow in the middle region of the chamber and less air flow at the bottom. Similarly, a person having delicate hair may desire very little exsiccating air flow near the top of the chamber so that his or her hair is not over heated. The ability to adjust air flow within the chamber is also desirable when the invention is utilized for drying pets. Cats and dogs often have varying amounts of hair. And more particularly, dogs such as poodles often have a wide range of hair thickness about the body. The invention may be adjusted so that a body requiring different amounts of exsiccation at different points on the body may be dried quickly and efficiently without underdrying or overdrying a particular region of the body.

Interchangeable and/or adjustable nozzles may be used that are also designed to accommodate a veneer or surfacing on the chamber walls. The nozzles may include flanges that aid in holding a veneer firmly in place. This is desirable to improve the aesthetic qualities of a chamber. For example, it may be desirable to apply marble, paneling having textured surfaces, or other attractive wall coverings to the interior of the chamber. Such a wall covering, or veneer, may be held in placed only by the flanges of the nozzles. This allows an owner to relatively easily replace the paneling or veneer by removing the nozzles. Those skilled in the art of interior design will appreciate that this is feature is beneficial in allowing an owner to redecorate a bathroom area, including the exsiccation chamber, without incurring excessive time and expense.

The drying air exits the chamber through the portal so that no exit vent or suction is required. When used for pets, the chamber may include a preferably air permeable door to hold the animal being dried. This provides the additional advantage of eliminating the need of holding an unhappy animal while it is being dried and thus avoiding injury. An alternative embodiment provides an entrance and an exit, making the chamber especially suitable for larger animals such as horses, ponies, cattle, and even larger animals such as elephants. The floor of the chamber is preferably made of a tactile, slip resistant material. In the case of outdoor, larger chambers such as those for accommodating horses and the like, the floor may consist simply of grass, dirt or straw. The floor is preferably comprised of material that is slip-resistant and impermeable to water.

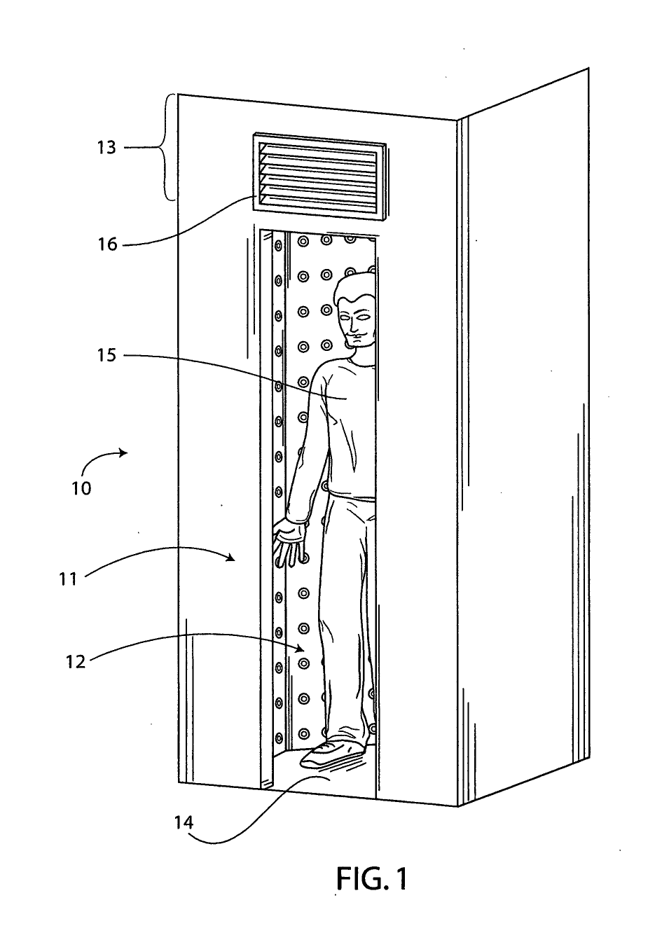

FIG. 1 shows a perspective view of a drying system 10 of the invention. The drying system 10 typically requires the space of a small closet. Portal 11 leads into chamber 12 having a slip resistant floor 14. Vent 16 provides air to a ventilator and heating element located inside a ventilation housing 13 above chamber 12. The chamber 12 is sized to comfortably accommodate an average sized person 15. Those skilled in the art of body maintenance will appreciate that it may be desirable to have a chamber substantially larger than the one shown in FIG. 1 in order to accommodate a person of larger than average size or to allow two or more persons to dry simultaneously. However, it is typically not desirable to design the drying system 10 or chamber 12 substantially larger than is required due to space constraints and the desire to both maximize efficiency and reduce the amount of energy required to dry a person. A larger chamber requires more heated air to fill the volume and dry a person. Therefore, it is generally preferred to have a drying system that occupies the space of a small closet having the minimum volume to comfortably fit an occupier. The drying chamber is usually of a cylinder geometry or optionally an elongated hemisphere, a right uniform prism or a cupula elongated by a corresponding right uniform prism. Other geometries may also be employed.

Floor 14 of the drying exsiccation chamber is preferably comprised of a relatively soft, slip resistant surface. Those skilled in the art will appreciate that there are several materials, include several polymeric materials such as, for example, rubber, that are suitable for use as a floor for the chamber 12. Other surface materials, such as many indoor carpets are also not preferable as they tend to faster growth of bacteria and other microorganisms when exposed to moisture. Materials known in the art and commonly found on floor surfaces in environments where persons are typically found barefoot and wet, for example, pools, locker rooms, docks, boat and other decks, etc., are most suitable for the chamber of the present invention. It is also suitable to utilize a relatively slippery surface, such as a tile or marble surface, when it is used in conjunction with a covering such as a bath mat. This is typically not preferred, however, as one of the benefits of the invention is the elimination of materials that require laundering or other washing and that may foster the growth of undesirable microorganisms.

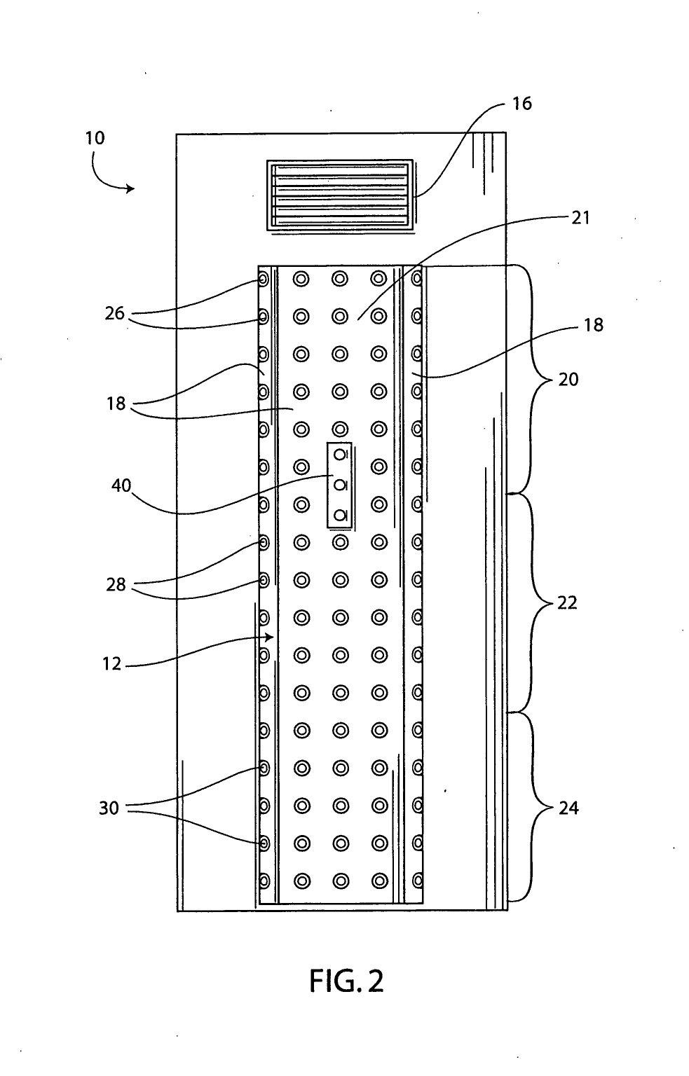

FIG. 2 shows a front view of the drying system 10. Chamber 12 is defined by an inner wall 21 formed from a plurality of wall panels 18. Panels 18 are preferably unitary panels comprised of a lightweight but sturdy material such as fiberglass, polyolefins of varying densities, plastics or the like. Preferably the inner wall 21 is comprised of materials that are both lightweight and relatively unaffected by moisture. However, very heavy materials such as stone or metal may be used if desired. In this embodiment, inner wall 21 is comprised of a plurality of panels 18. However, inner wall 21 may also optionally be comprised of a unitary body.

The present invention may be combined with a shower stall by including a drain on the floor, a door or curtain on the portal and a shower head in the chamber, in which case the material for the inner wall should be water resistant as with typical shower stalls.

Inner wall 21 includes several outlets 30. Each outlet 30 may be simply an aperture or may be an aperture with a nozzle attached. The outlets 30 allow air inside a plenum located behind the panels 18 to enter chamber 12. The strength of the air flow through the outlets depends upon the air pressure in the plenum. The air pressure in the plenum is typically greatest closest to the vent that provides air to the plenum. In the present invention, the sizes of the outlets are used to control the air pressure of the air jets emitted by the outlets. Typically, outlets near the source of a plenum's air are smaller and outlets further from the air source are larger. This results in all of the outlets providing approximately the same air pressure so that all of the outlets provide jets of equal strength. Were all of the outlets to have the same size, then those outlets proximal to the air source would have high pressure jets of air and those outlets distal to the air source would have little or no air pressure.

Vent 16 is located above chamber 12 and provides air to a ventilator that feeds the plenum as described below. The vent 16 preferably has vanes or other coverings to minimize the view of the inlet and prevent large objects from entering it. Vent 16 also preferably includes a filter that may be easily replaced or cleaned as part of routine maintenance. Inclusion of a filter prevents particulate matter in the air from entering and attaching to the ventilation system, plenum, heating element and outlets. In this embodiment, the vent 16 is found above entrance 11. This embodiment includes a ventilation system above the exsiccation chamber 12. However, vent 16 may be located anywhere that is relatively proximate the ventilation system.

Control panel 40 is located inside chamber 12 within easy reach and sight of an operator. Optionally, control panel 40 may be located outside chamber 12 or even on a remote control device. Control panel 40 allows for adjustment of temperature and flow rate of the air by controlling the heating element and the ventilator. Control panel 40 also optionally includes a timer and a variety of other controllers for operating various devices including, but not limited to, lights, audio and visual entertainment components, various communications devices and the like.

Chamber 12 may optionally be divided into three sections. Upper section 20, middle section 22 and lower section 24. Each section is located different distances from the ventilation assembly located above chamber 12. It may therefore be desirable for upper section 20 to have outlets small in size. Section 22 may have larger outlets and section 24 may have the largest outlets. This results in all of the outlets providing substantially the same air flow through them. This allows a body to be dried evenly. FIG. 2 illustrates the division of a chamber into three sections. However, a chamber could be similarly divided into only two sections, or into four or more sections. Were the outlets all of the same size, the outlets near the air source would provide substantially stronger jets, drying the upper portion of the body quickly, drying the middle portion more slowly, and drying the bottom portion extremely slowly, if at all. By adjusting the size of the outlets according to the distance from the plenum's air source, all of the outlets provide jets of air of the same strength. The size of the outlets may be determined by the actual size of the opening in the wall itself. Alternatively, the chamber inner wall may have apertures all of the same size but fitted with nozzles of different sizes. This allows the size of the outlets to be changed by replacing the nozzle with one of a different size. This is also advantageous in that it allows a new owner to readjust a chamber so that the airflows of the outlets better accommodate his or her size. Similarly, if an operator loses or gains weight, he or she may adjust the distribution of different sized nozzles to better accommodate his or her body. If adjustable nozzles are utilized with the invention, they may be adjusted individually. Furthermore, should an owner prefer, individually adjustable nozzles may be electronically actuated and set to accommodate different users. The exsiccation chamber may include a computer processor with its controls such that it may store preprogrammed nozzle settings, much as some car seats store preprogrammed seat adjustments for different users.

The invention's use of outlets having different sizes eliminates the need for manifolds, pipes, hoses and other elaborate methods of regulating air flow through outlets dispersed about the chamber. Furthermore, because the air flow rates through the outlets are adjusted by relative cross sectional size of the outlets, they are relative to each other and all increase or decrease relative to the air pressure within the plenum. Therefore, when an operator increases the power sent to a ventilator and thus increasing the air supply to the plenum, all of the outlets of the chamber increase their air flow by the same percentage. Because the outlets are either permanently or semi-permanently adjusted relative to one another, there is no need to adjust individual nozzles on the outlets or to adjust individual sections of outlets in order to uniformly increase the air flow and air temperature in the chamber to expedite exsiccation. Of course, those skilled in the art will appreciate that these and other options may be included with the invention should an operator desire them.

Generally, however, it is preferred to use one or more panels to form the chamber, with the panels having apertures of uniform size so that nozzles may be used to adjust the size of the outlets. A simplified embodiment would include one or more panels having differently sized apertures, with aperture size increasing along the length of the panels in order to create uniform airflow. An even more simplified version of the invention utilizes one or more panels with apertures all of the same size. The use of nozzles of varying size to create constant airflow from all of the outlets also provides a manufacturing advantage. All of the panels used to form the chamber may be produced having openings of the same size and evenly distributed. Those skilled in the art will appreciate that this greatly simplifies manufacture of the panels. This also aids in installation in that the same paneling material may be custom cut to accurately meet the dimensions of a particular space.

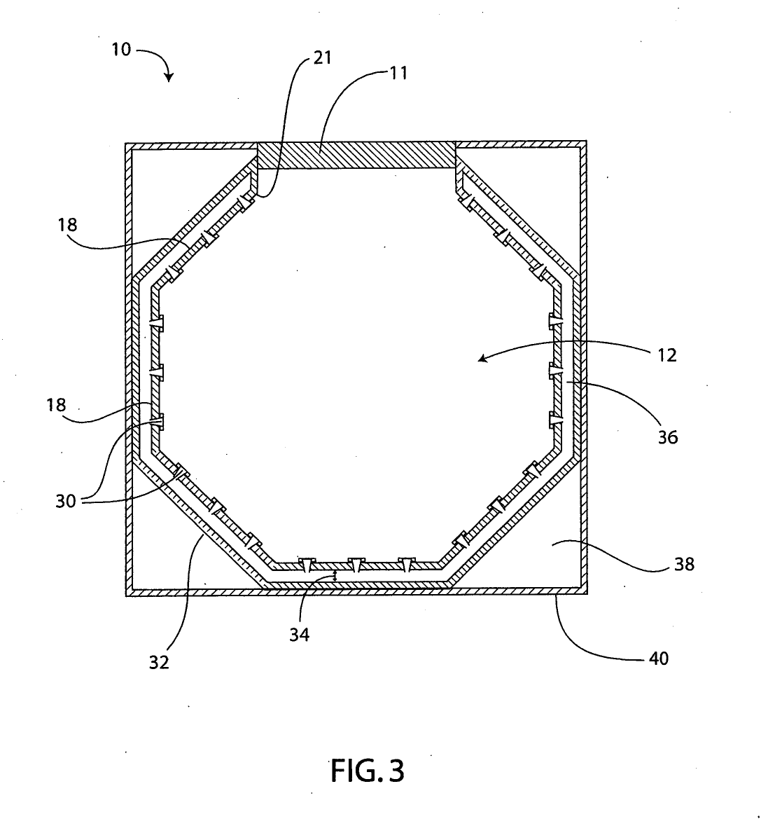

FIG. 3 shows a top cross sectional view of the exsiccation chamber 12 having portal 11 for entering and exiting the chamber 12. Panels 18 make up chamber wall 21 and include outlets 30. Inner chamber wall 21 is surrounded by plenum 36 formed between inner wall 21 and outer wall 32. Outer wall 32, like inner wall 21, may be a single unitary wall, or may be comprised of a series of panels. Outer wall 32 and inner wall 21 are equidistant throughout the exsiccation system so that the plenum has uniform thickness 34. This uniform thickness increases the efficiency of air flow through the plenum, decreases the amount of energy required to dry a body in the chamber and works in conjunction with the variably sized outlets to optimize air flow through the chamber and drying of a body in the chamber. Drying system 10 is encased in cabinet 40. Cabinet 40 is designed to fit into a rectangular, specifically square, area while chamber 12 is octagonal. Because of this, outer wall 32 forms void spaces 38 with cabinet 40. Although void spaces 38 constitute wasted space, an exsiccation system designed this way has increased efficiency because both the plenum 36 and chamber 12 have lower volumes, requiring less air. This requires less work performed by the ventilator and heating element, which saves energy. The smaller space of chamber 12 also means that a lower flow rate is required to adequately impinge heated air upon a body than would be required were the chamber larger.

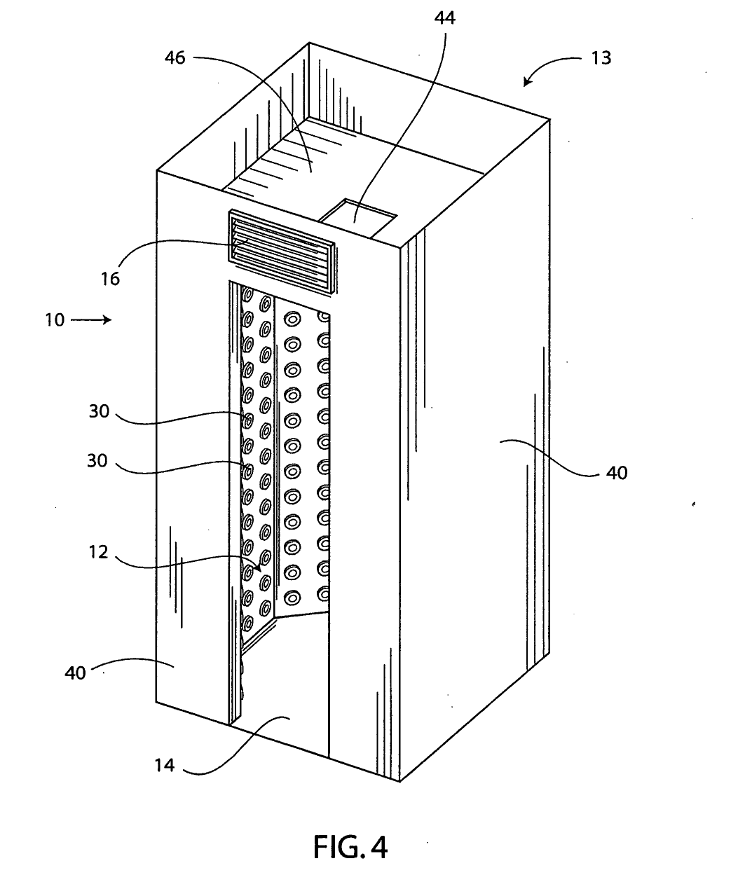

FIG. 4 shows the drying system 10 with the ventilation housing 13 open and exposed. In this embodiment, the outer wall 46 also serves as the bottom of ventilation housing 13. Although it some instances it may be desirable for the ventilation housing to be incorporated into the plenum such that there is no plenum feed vent and the ventilation system is located within the plenum, it is usually preferred that the ventilation housing 13 be a separate compartment. This usually simplifies maintenance and reduces wear on the ventilator as it is not contained in a heated environment. Intake vent 16 provides air to the ventilation chamber. Heated air enters the plenum through plenum feed vent 44. It is typically preferred to have plenum feed vent 44 directly above chamber 12 such that plenum 36 is substantially symmetric, and preferably radially symmetric, about plenum feed vent 44. Locating feed vent 44 at a point of symmetry of the plenum promotes even distribution of the heated air to the plenum. The size of the outlets 30 into chamber 12 correlates in a directly proportional way to the distance of the outlets 30 from the feed vent 44. In this embodiment, outlets near the bottom of chamber 12 are larger than the outlets at the top of the chamber. Those skilled in the art will appreciate that the chamber may be formed substantially inverse to the embodiment shown in FIGS. 1-5. In an inverse embodiment, ventilation chamber 13 would be underneath the floor 14 of chamber 12 and the outlets would increase in size along the height of the chamber.

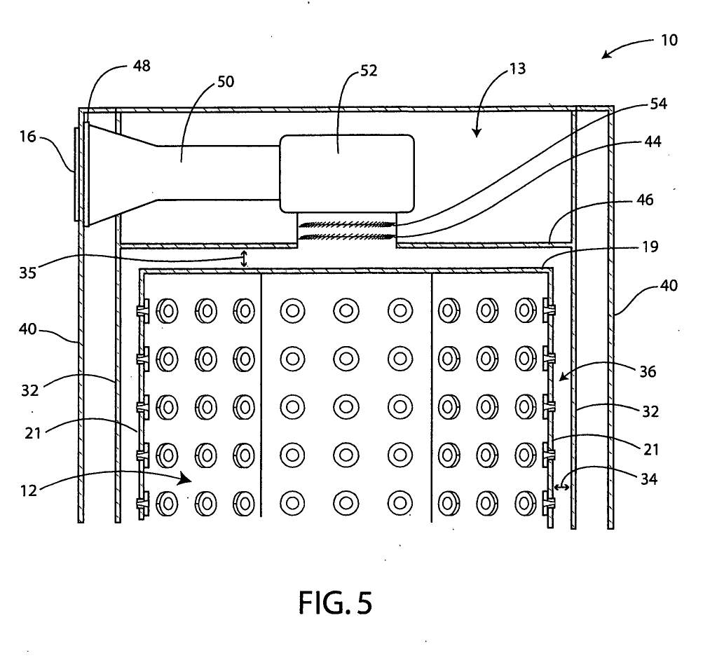

FIG. 5 shows a cut away view of the ventilation housing 13 of the drying system 10. Intake vent 16 is attached to duct 50 directly to ventilator 52. Filter 48 behind intake vent 16 is removable and/or cleanable in order to provide air substantially free of particulate matter to ventilator 52. Ventilator 52 may be a simple fan or other device capable of continuously supplying air to plenum 36. Ventilator 52 is preferably operable within a range such that the air pressure with which air is supplied to plenum 36 may be adjusted. In this manner, the air flow from the outlets into the chamber 12 may be increased or decreased uniformly throughout the chamber.

Ventilator 52 is in fluid communication with plenum feed vent 44. Between feed vent 44 and ventilator 52 is heating element 54. In this embodiment, heating element 54 comprises a pair of heating coils. However, any heating element that may be adjusted to transfer different amounts of heat to the air passing over/through it is suitable. By adjusting the heat provided by the heating element 54, the temperature of the air flowing into the exsiccation chamber may be adjusted. Those skilled in the art will appreciate that there are a variety of ventilators and heating elements and methods of combining the two that will be suitable for the invention. In this embodiment, the ventilator and heating element are shown as two separate components. However, it may be desirable to have them included in a single element. It may also be desirable to have the heating element located somewhere other than directly downstream of the ventilator. Furthermore, in some embodiments it may be desirable to have one or more heating elements within the plenum itself in addition to or in place of a heating element in the ventilation housing. By locating heating elements at various points in the plenum and provide separate adjustment for each, an operator would be able to adjust the amount of heat applied to different regions within the chamber.

As can also be seen in FIG. 5, inner wall 21 includes an inner end wall 19. Likewise, outer wall 32 includes outer end wall 46 that also serves as the bottom of the ventilation housing. In this embodiment, the distance 35 between inner end wall 19 and outer end wall 46 is equal to the distance 34, giving the entire plenum a uniform width. In this embodiment, distances 34 and 35 are about 1.5 inches. In other embodiments, these distances may not be equal. Additionally, in other embodiments the distance between the outer end wall and the inner end wall may not be uniform. However, it is generally preferred that even when the width of the plenum is not uniform, the feed vent still be located at a point of symmetry of the plenum.

In this embodiment the inner end wall 19 is planar. However, it may be desirable for the inner end wall to be a cupola having a hemispherical or polygonal design. The outer end wall may have a complimentary design to maintain uniform width of the plenum or may have a planar design, creating a plenum having a non-uniform width.

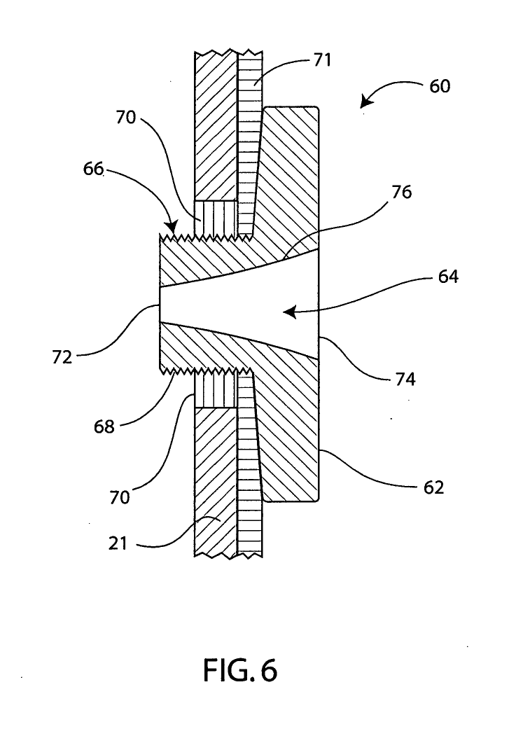

FIG. 6 shows a cross sectional view of a nozzle 60 incorporated into an aperture 66 in inner wall 21 to form an outlet 77. An outlet may be comprised of only an aperture in the inner wall of the chamber. However, it is generally preferable to have a plurality of outlets 77 each formed from apertures 66 that are all of equal size. The apertures are preferably evenly spaced throughout the inner wall 21. The air flow through each outlet is determined by the nozzle 60 attached to the aperture 66. Nozzle 60 is removably attached to aperture 66 so that nozzles having differently sized shafts 64 may be interchanged to adjust the airflow throughout the exsiccation chamber. In this embodiment of nozzle 60, shaft 64 tapers outward from inlet 72 to opening 74, giving shaft 64 a tapered frusta-conical shape. However, it may be desirable for shaft 64 have no taper and be cylindrical. Optionally, shaft 64 may have polygonal cross section.

The size of shaft 64 determines the air flow rate through outlet 77. If an operator or installer of the invention determines that the flow rate from a particular outlet is too low, he or she may simply replace the nozzle with one having a larger shaft. Conversely, an outlet with too high of an air flow rate may have its nozzle replaced with one having a smaller shaft. Should a user or operator determine that no air flow is desired from a particular outlet, an nozzle having no shaft may be inserted into the aperture.

Nozzle 60 preferably has a substantially cylindrical body 66 having a threaded exterior. Aperture 66 is preferably fitted with a corresponding threaded inset 70 that allows nozzle 60 to be inserted and adjusted to protrude a desired amount from the inner wall 21. Nozzle 60 also preferably includes flange 62. Flange 62 is preferably substantially circular, but may also be elliptical, rectangular or any other desired shape. Preferably, the nozzles will add ornamentation to the chamber in addition to being functional. Therefore, it may be desirable to provide a flange having an ornamental design.

Flange 62 allows nozzle 60 to form a tight frictional engagement to wall 21. Alternatively, flange 62 allows nozzle 60 to hold a veneer 71 in place against wall 21. Because nozzle 60 is removable, a veneer 71 may be easily replaced by removing the nozzles 60. Veneer 71 may be comprised of any desired material including marble, slate, plastic or any other material that adds aesthetic quality to the chamber.

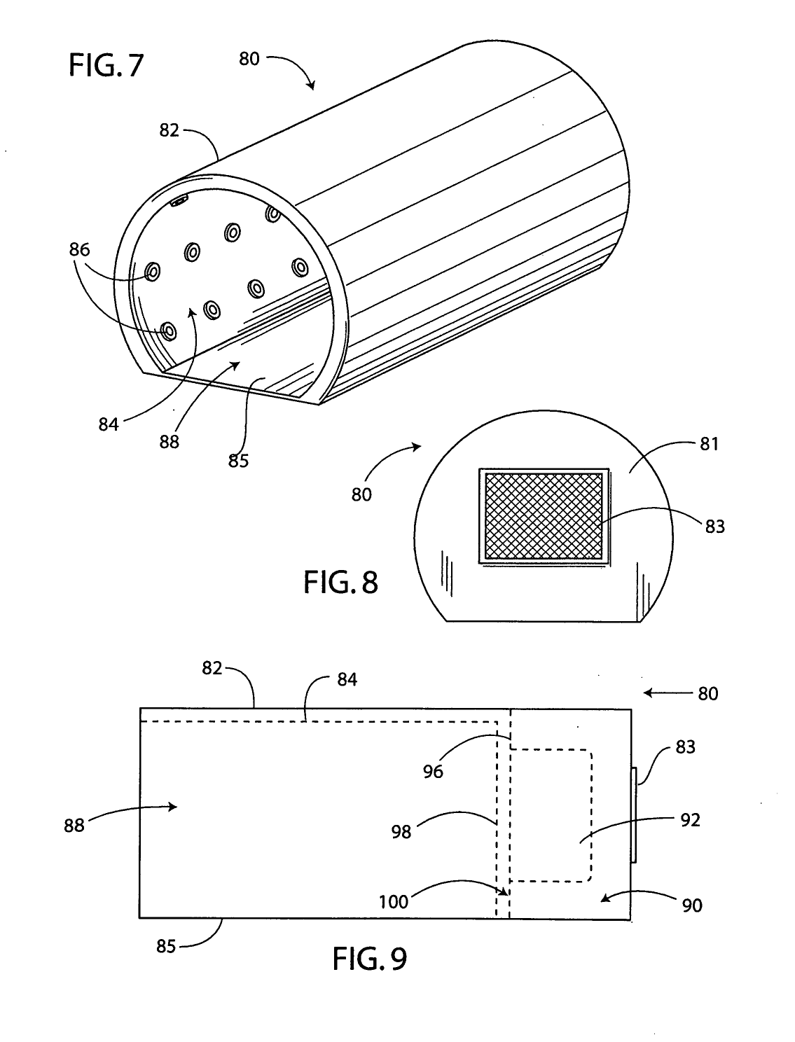

FIG. 7 shows a perspective view of an alternative embodiment of the invention. Exsiccation system 80 is designed for use with a small animal, such as a cat or dog. Chamber 88 is substantially cylindrical, and having floor 85. Outer wall 82 forms a plenum of substantially uniform width around inner wall 84 to provide heated air to chamber 88 by means of outlets 86. FIG. 8 Shows the rear wall 81 of exsiccation system 80 including air intake vent 83. In this embodiment, the ventilation housing is located at the rear of the chamber instead of above it.

FIG. 9 shows a cut away view of exsiccation system 80. Plenum 100 is formed between inner wall 84 and outer wall 82. Inner end wall 98 is part of inner wall 84 and outer end wall 96 is part of outer wall 82. Outer end wall 96 forms part of ventilation housing 90 and separates the ventilation housing 90 from plenum 100. Ventilator 92 has a heating element incorporated into it. In this embodiment, a duct is not used to place vent 83 in direct fluid communication with ventilator 92. As with the previous embodiment shown, plenum 100 does not extend into floor 85. While the plenum may be incorporated into the floor, this is typically not preferably as it increases the strength and sturdiness required of the plenum. By incorporating the plenum along the outside of the inner wall that does not support the weight of a body, a wider variety of materials and designs may be effectively used with the invention.

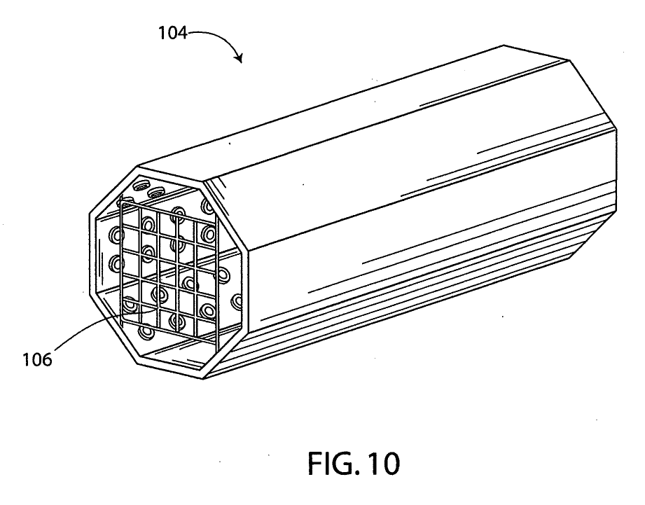

FIG. 10 shows an alternative embodiment of a pet exsiccation system 104 having an octagonal cross section. A variety of designs may be used, including ones having a variety of cross sectional shapes. Pet exsiccation system 104 also includes a door 106. Exsiccation chambers for use with pets preferably include a door to restrain a pet during the drying process. This prevents the pet from leaving the chamber during exsiccation and eliminates the need for a person to physically hold a pet while it is being dried. While exsiccation systems designed for people will often include a control panel within the chamber, systems designed for animals will preferably includes a control panel outside the chamber itself, either on the exterior of the exsiccation system or a more remote location.

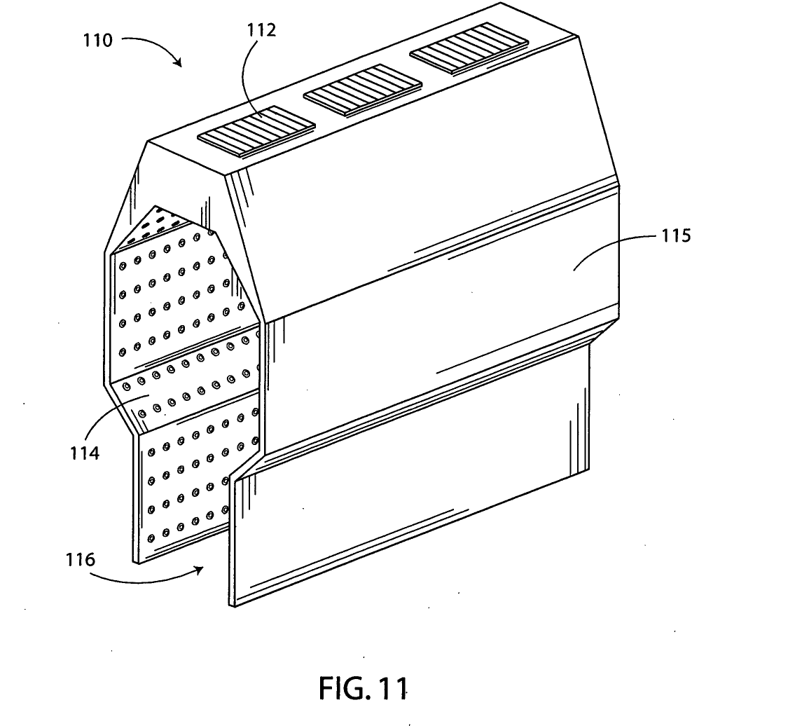

FIG. 11 shows a perspective view of an exsiccation system 110 for a large animal such as a horse. Exsiccation system 110 has a passageway 116 instead of a chamber. System 110 also does not have a floor. Although a floor could optionally be included, it is generally not considered necessary when the invention is used to dry a horse, pony, goat or other large animal because they are generally kept outside and there is no need to provide surface for them to step on. Intake vents 112 supply air to one or more ventilators in system 100. Inner wall 114 includes a plurality of air outlets and outer wall 115 forms a plenum around inner wall 114.

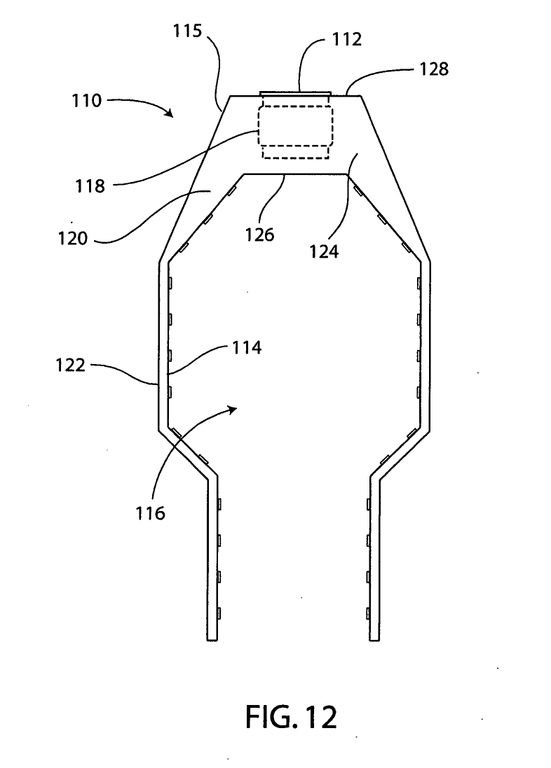

FIG. 12 shows a cut away front view of exsiccation system 110. Exsiccation passageway 116 is formed within inner wall 114. Plenum 120 is located between inner wall 114 and outer wall 115. Plenum 120 does not have a uniform width and is largest in plenum region 124 that also acts as a ventilation housing. Plenum 120 is narrowest along the sides of the passageway in plenum region 122.

In embodiment 110, ventilation system 118 includes a ventilator and a heating element and is located within the plenum between inner end wall 126 and outer end wall 128. In this embodiment, ventilation system 118 hangs from and is supported by outer end wall 128 and is attached to air intake vent 112. While this embodiment does not include a separate ventilation housing and a plenum feed vent, the ventilation system is located at a point of symmetry of the plenum, which is advantageous for the proper dispersion of air in the plenum.

The invention is not limited in its application to the details of construction and to the arrangements of the components set forth in the above description or illustrated in the drawings. The invention is capable of other embodiments and of being practiced and carried out in various ways. Also, the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention claimed is:

1. An air exsiccation system comprising:
a) an exsiccation chamber comprising an a portal, a floor and an inner wall, the inner wall having at least one layer and a plurality of apertures;
b) a plenum substantially surrounding the inner wall of the exsiccation chamber and comprising an outer wall;
c) a ventilation system comprising an intake vent, a ventilator, and a plenum feed vent;
d) at least one heating element; and,
e) a control panel;
wherein the ventilator receives air from the air intake vent and causes air to flow across the at least one heating element; and,
wherein the ventilator causes air to flow through the plenum and into the exsiccation chamber.

2. The exsiccation chamber of claim 1 wherein the inner wall is comprised of a plurality of sections including a first section close to the plenum feed vent and having apertures with a smaller size and a last section further from the plenum feed vent and having apertures of a larger size.

3. The exsiccation chamber of claim 1 further comprising a ventilation system housing attached to the outer wall and containing the ventilation system.

4. The exsiccation chamber of claim 1 wherein the distance between the outer wall and the inner chamber wall is uniform throughout the plenum.

5. The exsiccation chamber of claim 1 wherein the at least one heating element comprises a plurality of heating elements located within the plenum.

6. The exsiccation chamber of claim 3 wherein the at least one heating element is located in the ventilation housing.

7. The exsiccation chamber of claim 1 further comprising a door in the portal.

8. The exsiccation chamber of claim 1 further comprising a second portal.

9. The exsiccation chamber of claim 1 wherein the at least one layer of the inner wall comprises at least two layers including a veneer.

10. The exsiccation chamber of claim 1 further comprising a plurality of nozzles attachable to the apertures of the inner wall.

11. The exsiccation chamber of claim 10 wherein the apertures each have a distance from the plenum feed vent, wherein apertures having a lesser distance from the plenum feed vent have nozzles that provide a lesser lower airflow rates than the nozzles of apertures having a greater distance from the plenum feed vent.

12. The exsiccation chamber of claim 10 further comprising a ventilation system housing attached to the outer wall and containing the ventilation system.

13. The exsiccation chamber of claim 10 wherein the distance between the outer wall and the inner chamber wall is uniform throughout the plenum.

14. The exsiccation chamber of claim 10 wherein the at least one heating element comprises a plurality of heating elements located within the plenum.

15. The exsiccation chamber of claim 13 wherein the at least one heating element is located in the ventilation housing.

16. The exsiccation chamber of claim 10 further comprising a door in the portal.

17. The exsiccation chamber of claim 10 further comprising a second portal.

18. The exsiccation chamber of claim 10 wherein the at least one layer of the inner wall comprises at least two layers including a veneer.

19. An air exsiccation system comprising:
a. An exsiccation chamber having an inner wall comprising at least one layer, a portal and a floor, wherein the inner wall includes a plurality of apertures;
b. a plenum surrounding the inner wall of the exsiccation chamber and comprising an outer wall;
c. a ventilation system comprising an intake vent, a ventilator, and a plenum feed vent;
d. at least one heating element; and,
e. a control panel for regulating the ventilator and the at least one heating element;
wherein the ventilator receives air from the air intake vent and causes air to flow across the at least one heating element;
wherein the air pump causes air to flow through the plenum and into the exsiccation chamber; and,
wherein the inner wall is comprised of a plurality of sections, wherein each section comprises nozzles providing equal flow rates and wherein different sections comprise nozzles providing different flow rates.

20. A method of optimizing air flow rates from a plurality of apertures into an exsiccation chamber comprising:
a. providing an exsiccation chamber having an inner wall including a plurality of apertures, a floor and a portal, a plenum surrounding the exsiccation chamber, a plurality of interchangeable nozzles producing a plurality of flow rates and attachable to the apertures, and a ventilation system adapted to provide warm air to the plenum;
b. supplying air to the plenum;
c. adjusting the temperature of the air supplied to the plenum by applying a heating element to the air;
d. adjusting a rate of air flow through each of the apertures by attaching the nozzles to the apertures;
e. adjusting the flow rate of the air flow to the plenum;
Wherein the plurality of nozzles include nozzles having openings from about 0.125 inches to about 0.5 inches
